(19) United States
(12) Patent Application Publication
(10) Pub. No.: US 2008/0073198 A1
(43) Pub. Date: Mar. 27, 2008

(54) Concentrating solar distillation apparatus

(76) Inventor: Daniel Simon, Chicago, IL (US)

Correspondence Address: Daniel Simon;Apt 1003, 5555 N. Sheridan Rd., Chicago, IL, 60640, US

(21) Appl. No.: 11/498,455

(22) Filed: Aug. 3, 2006

(51) Int. Cl. B01D 3/00

(52) U.S. Cl. 202/81

(57) ABSTRACT

A solar distiller with a two part distilling chamber and a concentrating mirror which is designed to be lightweight and compact for ease of transport. The distilling chamber has two main parts; a trough for holding a liquid that will be distilled, and a condensing roof on which the liquid will condense that has channels for collecting the distilled liquid. The two part distilling chamber allows for simple operation and easy maintenance. The concentrating mirror is made from a flexible reflective sheet, which is formed into a nearly parabolic shape by the mirror frame. The mirror is designed so that it can be easily assembled and then later disassembled for storage or transport. A stand holds the distilling chamber at the approximate focus of the concentrating mirror. The concentrating mirror allows a relatively large amount of sunlight to be focused onto the distilling chamber producing a proportionately large amount of distilled liquid. The solar distiller is made from inexpensive materials and can be assembled and disassembled multiple times.

### BACKGROUND

1. Field of Invention

This invention relates to an apparatus, which uses the radiant energy of sunlight to distill liquids, such as generating fresh water from salty or otherwise undrinkable water. In particular it relates to a simple portable distiller that uses a flexible mirror to increase the amount of water distilled.

2. Discussion of Prior Art

There is a continuing, and in some cases increasing, need for additional clean water resources in many countries around the world. In addition to temporary interruptions to water supply caused by natural disasters, which occur with equal likelihood everywhere, there are also chronic supply problems in many regions, especially in developing countries. Solar energy is a cheap and readily available resource that can be used to produce large amounts of fresh water provided a simple and inexpensive means is devised to harness it. The prior art contains many inventions that use sunlight to heat and distill water, brine, seawater, or other liquids. Broadly speaking these devices can be classified as using one or a combination of the following configurations: heat absorbing plates, box stills, multiple effect stills, or concentrating devices using either lenses or mirrors. Such inventions strive to utilize the diffuse but substantial energy contained in sunlight to evaporate the input water and then condense and collect the distilled water. Unfortunately the inventions disclosed in the prior art are overly complex, expensive to manufacture, wasteful of material or sunlight, difficult or costly to operate and maintain, cumbersome to transport, or some combination of the above.

In general terms solar devices produce in proportion to the amount of sunlight they intercept. A number of solar devices like box stills and heat absorbing plates try to make the best use of the sunlight that naturally falls on them. One disadvantage of these devices is their tendency to reradiate out of the device a substantial fraction of the energy they absorb. In order to overcome this disadvantage many inventors design additional features or mechanisms thereby increasing the overall complexity of the device and adding to the cost of maintenance or operation. The prior art contains many examples of each type, U.S. Pat. No. 5,628,879, to Woodruff discloses a box still type and U.S. Pat. No. 6,001,222 to Klein discloses a heat absorbing plate type. While these may be useful devices, they and all devices like them are wasteful of material in that they don't attempt to concentrate the sunlight falling on them before converting and/or using the solar energy. If instead they concentrated the sunlight that falls on them they would either produce more for a given area (i.e. amount of material) or they could be made with less material.

The prior art also contains disclosure of a large number of devices, which use concentrating mechanisms. Disadvantages of devices that rely on concentration, using either lenses or mirrors, include complex design, a need for precision placement or motion of parts, high cost of manufacture and parts due to tight tolerances or exacting surface requirements, or excessive bulk or weight which make them cumbersome to transport, and ongoing high costs needed to operate or maintain them.

One reason for the extra cost and complexity of concentrating devices is the tendency to design and use parabolic surfaces which require a high quality and precise surface figure to work optimally. Parabolic surfaces generally focus light to a very narrow point, spot, or line where the heat is generally absorbed and transferred to a liquid or fluid such as water. Unfortunately high quality and precise parabolic or even circular surfaces are relatively expensive to manufacture and require extra care and expense to maintain.

Also disclosed in the prior art are a number of devices, for concentrating solar energy, that use a flexible sheet of aluminum coated plastic, such as aluminized Mylar, to form the concentration surface. These inventions each disclose a unique geometry and arrangement of structural supports, bars, members, connections, ribs, wires, etc., used to form the desired concentrating surface (i.e parabolic, catenary, cylindrical, etc.). Unfortunately each of the inventions which relate to flexible Mylar sheets in particular, contain excessive or redundant parts, the manufacture of complex shapes, and costly mechanisms to fine tune or perfect the shape of the desired concentrating surface. While not all related to solar distillation the following patents all disclose concentrating devices that exhibit at least one and often some combination of the above noted disadvantages, U.S. Pat. No. 4,611,575 (1986) to Powell, U.S. Pat. No. 4,504,362 (1985) to Kruse, U.S. Pat. No. 4,312,709 (1982) to Stark, U.S. Pat. No. 4,293,192 (1981) to Bronstein, U.S. Pat. No. 4,240,406 (1980) to Hutchinson, U.S. Pat. No. 4,173,397 (1979) to Simpson, U.S. Pat. No. 4,168,696 (1979) to Kelly, and U.S. Pat. No. 4,119,365 (1978) to Powell.

### SUMMARY OF THE INVENTION

The concentrating solar distiller of this invention uses a simple two part distilling chamber, and a flexible sheet mirror supported such that the distilling chamber is at the approximate focus of the mirror. The two part distilling chamber allows the user to easily disassemble the device for compact storage or cleaning. The flexible sheet mirror is made from inexpensive and lightweight materials, which can be rolled up or stacked compactly for shipping and yet is easy to assemble. The mirror is assembled into a bow shape (i.e. nearly parabolic in one dimension) such that it concentrates sunlight on the distilling chamber. The mirror increases the amount of sunlight falling on the distilling chamber several fold, increasing by several times the amount of water that may be distilled in a given amount of time. Because of the geometry involved, the surface of the mirror does not have to conform exactly to a precise curve, which allows lower cost materials, loser tolerances, and simplified shapes to be employed in its manufacture.

### Objects and Advantages:

### Accordingly several objects and advantages of my invention are

a) to provide a simple to use solar distillation apparatus which can be made of inexpensive materials;
b) to provide a portable solar distillation apparatus which can be stored compactly for ease of transport;
c) to provide an easily manufactured and assembled solar distillation apparatus;
d) to provide a solar distillation apparatus that is easy to operate and inexpensive to maintain;
e) to provide a solar distillation apparatus which uses a concentrating mirror to minimize waste of material and solar energy;

### Further objects and advantages of my invention will become apparent from a consideration of the drawings and ensuing description.

### DESCRIPTION OF THE DRAWINGS

FIG. 1 shows a perspective view of the solar distillation apparatus with arrows indicating the flow of liquid into and out of the distilling chamber.

FIG. 1A shows a cross section of the mirror frame.

FIG. 2 shows a perspective view of the preferred embodiment of the solar distillation chamber.

FIG. 3 shows a side view of the preferred embodiment of the solar distillation chamber.

FIG. 4 shows a cross section of the condensing roof shown in FIG. 2.

FIG. 5 shows a perspective view of the evaporating basin which forms the bottom half of the distillation chamber shown in FIG. 2 and FIG. 3.

Several illustrations and drawings have been presented to better aid in the understanding of the present invention. The scope of the present invention is not limited to what the figures show.

### DETAILED DESCRIPTION OF THE INVENTION

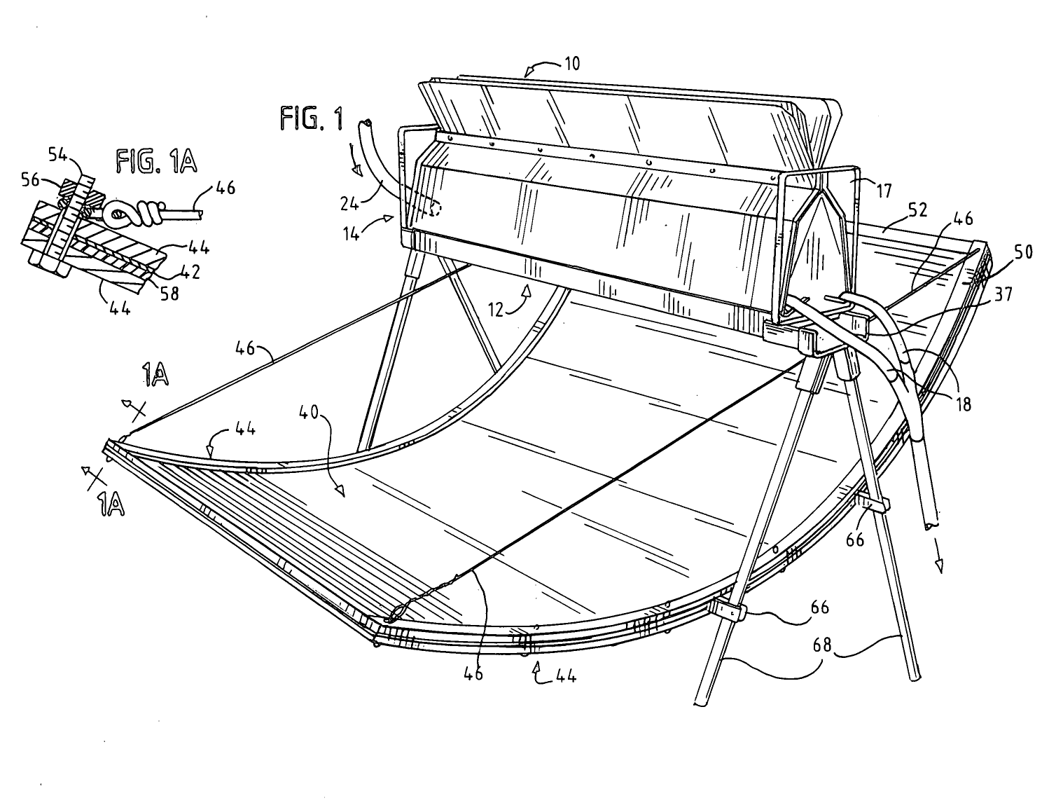

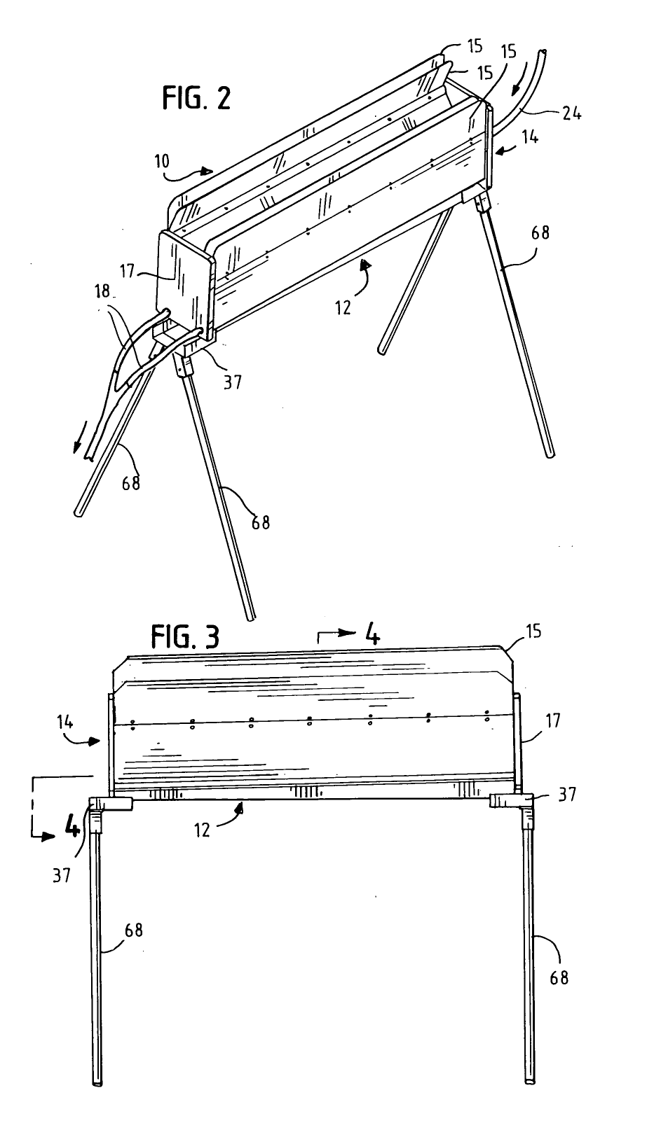

An embodiment of the concentrating solar distiller of this invention is illustrated in FIG. 1. There are two principle elements shown, a distilling chamber 10 and a concentrating mirror 40.

The distillation of liquids, which may commonly be water for drinking, occurs in the distilling chamber 10. Distilling chamber 10 consists of two main parts, an evaporating basin 12 which fits under a condensing roof 14.

Evaporating basin 12, shown as an elongated shallow trough in FIG. 5, must be able to hold water and should be made of a material that conducts thermal energy from its exterior surface 32 to the raw water inside. Evaporating basin 12 has leg brackets 37 (for attaching legs 68) protruding horizontally from each end. In the preferred embodiment, evaporating basin 12 is made from aluminum, although other materials such as plastic, tin or stainless steel may be used, and has its exterior surface 32 darkened to absorb solar radiation.

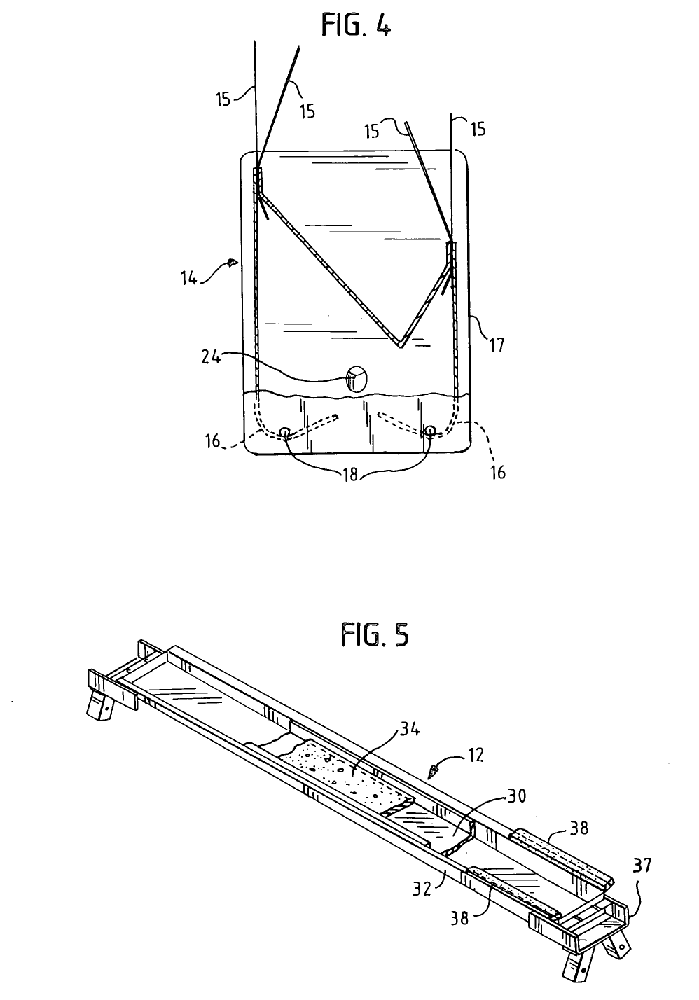

Condensing roof 14, shown in FIG. 4 as a lopsided “M”, along with the two end caps 17, should form a substantially airtight seal where it meets evaporating basin 12. Condensing roof 14 can be made from a single extruded sheet or can be comprised of a plurality of strips of material joined together at various advantageous locations, like the shoulders of the “M”, such that an airtight seal is formed. Also present if condensing roof 14 is made with a plurality of strips joined together is at least one cooling fin 15, which is a heat conducting metal sheet, such as aluminum, running the length of condensing roof 14 with most of its surface area outside the distilling chamber 10 but a small amount of its surface area inside. Cooling fin 15 helps to transfer excess heat from the interior of condensing roof 14 to the outside environment.

Also running the length of condensing roof 14 are two inward and upward curving edges, or channels 16, shown as dashed lines in FIG. 4. Each of the two channels 16, which form the bottom portion of condensing roof 14, connect to an exit tube 18 where the distilled liquid exits distilling chamber 10 and enters a distilled water reservoir (not shown). Condensing roof 14 is made of a transparent plastic in the preferred embodiment, but may be made using an opaque plastic or metal material. End caps 17 are flat plates of a plastic or metal material and are joined to condensing roof 14 using a manufacturing process or adhesive. The airtight seal between condensing roof 14 and evaporating basin 12 may be enhanced by inserting between them a gasket 38 made from a material such as cork, foam, or rubber.

A pair of screws (not shown), or equivalent reversible means, is located at either end of distilling chamber 10, to positively and reversibly hold condensing roof 14 against evaporating basin 12, with gasket 38 between, to ensure the substantially airtight seal described above. Also a basin liner 30, which can be made of a disposable material, is used to line the interior of evaporating basin 12, to prevent excess buildup of scale, salt or dirt within evaporating basin 12, and thereby facilitate cleaning. Also a wicking material 34 may rest on the bottom of evaporating basin 12 or on top of the basin liner 30. The wicking material 34 is made of a fabric, sponge, or sponge-like material that effectively increases the amount of water to air surface area thereby enhancing evaporation.

FIG. 1 and FIG. 1A show details of concentrating mirror 40 used to collect sunlight from a relatively large area and focus the sunlight onto evaporating basin 12. Concentrating mirror 40 consists of a reflective sheet 42, a pair of mirror frames 44, and a pair of shaping wires 46, to support and shape the reflective sheet 42. In the preferred embodiment reflective sheet 42 consists of a sheet of reflectively coated thin polymer material, such as aluminized Mylar™, held in a nearly parabolic shape by mirror frames 44 and shaping wires 46 as will be described. An optional backing sheet 58, made of plastic, aluminum or similar material may be included behind the reflective sheet 42 to help maintain the desired mirror shape.

Nearly parabolic is intended to mean a shape that closely approximates a parabolic trough, sometimes called a linear parabolic reflector, such that almost all of the incoming sunlight is focused onto the area of the evaporating basin's exterior surface 32. Since evaporating basin 12 has a finite width and height, a perfect parabolic trough surface capable of focusing sunlight to a line, is not needed. Instead the reflecting surface need only be good enough (i.e. nearly parabolic) at focusing light that almost all of the light be intercepted by evaporating basin 12.

As FIG. 1 shows each mirror frame 44 is composed of at least two longitudinal members 50 of equal length and at least two transverse members 52 of equal length. All members of mirror frame 44 are made of thin aluminum strips in the preferred embodiment, although steel, plastic, wood, or other materials can be substituted as appropriate. Each member of mirror frame 44 has a plurality of holes at roughly equal distances along them to allow joining using a bolt 54 and a nut 56 or equivalent reversible means. The longitudinal members 50, should flex without breaking when the ends are pulled a short distance toward each other.

The longitudinal and transverse members of mirror frame 44 are arranged to create a rectangle covering the outside edge of reflective sheet 42 such that reflective sheet 42 fills the interior area without significant obstruction. In the preferred embodiment, reflective sheet 42 and an optional backing sheet 58 are captured between two mirror frames 44 using a plurality of bolts 54 and nuts 56 (as shown in FIG. 1A), or equivalent joining device, such that mirror frames 44 and reflective sheet 42 may be separated if desired. Additional transverse members 52 may connect longitudinal members 50 along the underside of reflective sheet 42, or backing sheet 58 if used, at roughly equal distances from the other transverse members 52 to provide additional support for reflective sheet 42. Two shaping wires 46 of equal but shorter length than the longitudinal members 50, are secured to either end of each of the longitudinal members 50, causing the ends of longitudinal members 50 to bend up forming reflective sheet 42 into a nearly parabolic concentrator, as shown in FIG. 1.

FIG. 1 and FIG. 2 show leg brackets 37 which protrude from each end of evaporating basin 12 primarily allowing legs 68 to be attached that hold and support distilling chamber 10 at the approximate focus of concentrating mirror 40. Each leg bracket 37 should accommodate at least one and preferably two legs 68 such that the legs 68 hold one end of distilling chamber 10. The legs 68 can be made from a light weight tubular metal or plastic material and is made with aluminum tubing in the preferred embodiment. The end of distilling chamber 10 with exit tubes 18, should be at a slightly lower elevation from the other end, so the distilled water collected in the channels 16 will by force of gravity flow out exit tubes 18. Each leg 68 also has at least one mirror frame connection 66 where mirror frame 44 may be connected. Each leg 68 must be tall enough to support evaporating basin 12 at the approximate focus of concentrating mirror 40.

### OPERATION OF THE INVENTION

This concentrating solar distillation apparatus has been designed and should be built in such a way that it is lightweight and compact for ease of portability as well as easy to assemble and disassemble. It may be moved from one location to a new location and reassembled in the new location and operate satisfactorily in the new location. As a result each of the parts that can be assembled and disassembled has a means by which it can and should be secured, joined, supported or connected for operation.

The apparatus can be operated by first supplying water to evaporating basin 12 by adding raw water via input tube 24 manually or to an optional raw water reservoir that is connected to input tube 24 with a valve for regulating the flow of raw water into evaporating basin 12. When concentrating mirror 40 is connected and supported by the appropriate mirror frame connection 66 such that nearly all of the solar energy is concentrated on evaporating basin 12, solar energy will heat evaporating basin 12 which will in turn heat the raw water inside. As the raw water inside evaporating basin 12 is heated it will evaporate at an increased rate. This water vapor will condense on the inside surface of condensing roof 14, where it will by force of gravity run down the sides of condensing roof 14 and collect in one of the two channels 16 designed to catch the distilled water. This water will then run along channel 16 and out exit tube 18 where it will finally collect in a distilled water reservoir. Concentrating mirror 40 can be repositioned using the provided mirror frame connection(s) 66 to track the sun.

It is assumed that evaporating significant quantities of raw water will over time lead to a build up of minerals or salts in evaporating basin 12. Thus distilling chamber 10 can be disassembled by removing the screws from each end and lifting the condensing roof 14. At this point evaporating basin 12 can be cleaned or scrubbed to remove mineral and salt build-up. Additionally basin liner 30 can be used to line evaporating basin 12 and reduce the amount of mineral or salt that would otherwise accumulate on evaporating basin 12. Basin liner 30 may then be cleaned or disposed of as the user desires.

### DESCRIPTION AND OPERATION OF ALTERNATIVE EMBODIMENTS

Depending on the season and the latitude where the concentrating solar distillation apparatus is operating some sunlight may be reflected past the end of the evaporating basin 12 and it may be desirable to add a secondary flat or “fold” mirror as an attachment to the legs 68 on the side furthest from the sun to reflect sunlight back onto the evaporating basin 12.

Depending on the circumstances it may be desirable to use only a single leg 68 attached to each leg bracket 37, if for example the user is most concerned with securing the device against possible theft than enhancing portability. Each of the two legs 68 could then be secured to a large metal plate, embedded deep in the ground, or set in concrete.

### CONCLUSION, RAMIFICATIONS, AND SCOPE OF INVENTION

While the above description contains many specifications these should not be construed as limitations on the scope of the invention, but rather as an exemplification of one preferred embodiment thereof. Many other variations are possible, for example an active (i.e. automatic) sun tracking system could be employed. The active tracker could (mechanically) orient or rotate concentrating mirror 40 such that throughout a day concentrating mirror 40 would change position multiple times to reflect sunlight optimally onto evaporating basin 12 whatever the hour.

Additionally the condensing roof 14 can be shaped with a sloped or multifaceted ceiling, flat or sloped sides and v-shaped channel along the bottom inside edge. Also a wicking material 34 may be used in evaporating basin 12 to enhance the evaporation of the raw water, in a manner disclosed elsewhere and consistent with the prior art.

Additionally the evaporating basin 12 can have a selective coating, which is a coating designed to maximize heat absorption while minimizing heat radiation from a surface, applied to exterior surface 32 in place of, or in addition to darkening exterior surface 32.

Accordingly the scope of the invention should be determined not by the embodiment(s) illustrated, but by the appended claims and their legal equivalents.

1. A solar energy powered apparatus for distilling liquids, such as water, comprising
a) a distilling chamber comprising an evaporating basin and a condensing roof having a pair of interior channels running substantially the length of said condensing roof and a reversible means for holding said condensing roof on said evaporating basin to form a substantially airtight seal
b) a collapsible concentrating mirror comprising a flexible reflective sheet and a mirror frame comprising a forming means to support and shape said reflective sheet such that it concentrates solar energy
c) a stand for supporting said distilling chamber above and at the approximate focus of said concentrating mirror
d) an exit tube for removing a condensed liquid, including water, which collects in said channels from said distilling chamber
e) an input means for adding a raw liquid, including water, to said evaporating basin.

2. The solar energy powered apparatus for distilling liquids defined in claim 1 wherein said evaporating basin has an elongated trough shape and is made from a material that conducts thermal energy, has an outer surface that is darkened to absorb solar radiation, and has a leg bracket extending from either end to facilitate mounting said distilling chamber with said stand.

3. The solar energy powered apparatus for distilling liquids defined in claim 2 wherein said evaporating basin has a removable liner, which may be cleaned or disposed of, to reduce scale buildup within said evaporating basin and a gasket running along the top surface of said evaporating basin to enhance an airtight seal when said condensing roof is located and reversibly held on top of said evaporating basin.

4. The solar energy powered apparatus for distilling liquids defined in claim 3 wherein said condensing roof has a set of end caps and is made from plastic and shaped like a lopsided “M” with inward and upward curving edges forming said channels.

5. The solar energy powered apparatus for distilling liquids defined in claim 3 wherein said condensing roof has a set of end caps and is made from plastic and house shaped with inward and upward curving edges forming said channels.

6. The solar energy powered apparatus for distilling liquids defined in claim 4 wherein said condensing roof is made from a plurality of plastic pieces joined together with a plurality of fasteners at each joint, such that each joint is capable of maintaining a substantially airtight seal and has at least one metallic fin placed between said plastic pieces to increase heat transfer from said condensing roof to the surroundings.

7. The solar energy powered apparatus for distilling liquids defined in claim 6 wherein said reflective sheet is made from a reflectively coated polymer sheet.

8. The solar energy powered apparatus for distilling liquids defined in claim 7 wherein said forming means comprises an equivalent upper frame and lower frame each comprising a pair of longitudinal members and a plurality of transverse members of predetermined length and having said reflective sheet held between said upper frame and said lower frame which are then reversibly held together with a plurality of bolts and nuts and having a pair of shaping wires of shorter length than said longitudinal members, with each of said shaping wires attached to the ends of one of said longitudinal members causing said longitudinal members to bend up whereby a concave and nearly parabolic concentrating mirror is formed.

9. The solar energy powered apparatus for distilling liquids defined in claim 8 wherein said stand comprises a pair of supports located at either end of said distilling chamber and where each of said supports comprise a pair of legs with each of said legs fitting into said leg bracket extending from either end of said evaporating basin and where said legs angle down and away from each other.

10. The solar energy powered apparatus for distilling liquids defined in claim 9 wherein said stand has a plurality of mirror frame connections to allow said concentrating mirror to be reoriented during a day to track the sun and where said stand is arranged such that the side of said distilling chamber with said exit tube is at a slightly lower elevation allowing distilled water which collects in said channels to exit said distilling chamber through said exit tube by force of gravity.

11. The solar energy powered apparatus for distilling liquids defined in claim 10 wherein said reversible means comprises a pair of screws at either end of said evaporating basin that mate with tapped holes in said end caps of said condensing roof.

12. The solar energy powered apparatus for distilling liquids defined in claim 11 wherein said input means includes a raw liquid reservoir located above and connecting to said evaporating basin by a tube with a valve able to regulate the flow of raw liquid entering said evaporating basin.

13. The solar energy powered apparatus for distilling liquids defined in claim 12 further including a secondary mirror which is flat but otherwise made from the same materials as said concentrating mirror, and attached to one of said supports whose function is to reflect sunlight onto said evaporating basin which would otherwise converge to a point beyond the end of said evaporating basin.

14. The solar energy powered apparatus for distilling liquids defined in claim 8 wherein said stand comprises a pair of supports located at either end of said distilling chamber and where each of said supports comprise a single vertical leg which supports one end of said distilling chamber using said leg bracket extending from either end of said evaporating basin.
